(19) United States
(12) Patent Application Publication
(10) Pub. No.: US 2007/0134437 A1
(43) Pub. Date: Jun. 14, 2007

(54) Surface treatment method for material with surface microstructure

(75) Inventors: Kon-Tsu Kin, Hsinchu (TW); Pei-Lin Chang, Hsinchu (TW); Chiou-Mei Chen, Hsinchu (TW); Yi-Ching Chen, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/636,575

(22) Filed: Dec. 11, 2006

(30) Foreign Application Priority Data
Dec. 13, 2005 (TW) 94144139

(51) Int. Cl. B05D 3/00

(52) U.S. Cl. 427/532

(57) ABSTRACT

A surface treatment method for material with surface microstructure includes the steps of subjecting the material surface to a dry-type free-radical oxidation treatment, and using a supercritical fluid to purge the surface of the material with surface microstructure, so as to remove oxidized and bond-broken small molecules from the material surface. The surface microstructure may include nanoholes or high-aspect-ratio microstructures. Small molecules or moistures in the nanoholes or the high-aspect-ratio microstructures are carried by the supercritical fluid away from the material with surface microstructure.

### FIELD OF THE INVENTION

The present invention relates to a material surface treatment method, and more particularly to a surface treatment method for material with surface microstructure.

### BACKGROUND OF THE INVENTION

In response to future product requirements, many elements for electronic products are designed to be finer, more complicate, and more densely distributed. Therefore, microstructure elements have been gradually reduced from micron size, to sub-micron size, and to nano size. A microstructure material includes many tiny surface structures, such as nano-scale grooves and pores. Substances used in manufacturing the microstructure material and entered into such nano-scale grooves and pores are not easily removable. Impurities on the surface of the microstructure material frequently result in changes in the electrical properties of the produced element or defects in the surface properties of the produced element. Therefore, it is necessary to include a purging step in the manufacturing process to eliminate such impurities from the element surface. In conventional purging methods, a large amount of highly oxidizable solution, organic solvent, or acid/alkaline solution must be used to purge the produced element. While the conventional purging methods are effective to some extent, they would subsequently produce large amount of waste water and waste acid/alkaline liquor, which tend to cause product contamination and environmental pollution, and increase cost for wastewater treatment.

When an element has high-aspect-ratio microstructures, general solvents that have large surface tension are not able to accurately enter into such microstructures to carry away impurities therefrom, resulting in residues of impurities in the microstructures. Then, when the element is subjected to subsequent drying, the microstructures of the element might very possibly be damaged to result in degradation of element properties.

There has been developed a purging process using a supercritical fluid (SCF). U.S. Pat. No. 6,306,754 discloses the use of a supercritical fluid to clean etched pores and purge off residual photo-resistant. Supercritical fluids have special nature of low surface tension and high diffusion, and may wet and permeate into very fine microstructures, porous materials, or structurally complicate parts or components. When the low-volatile fluid material has been dissolved by the supercritical fluid, it can be purged off by high-pressure gas to achieve the purpose of cleaning. The supercritical fluid is suitable for purging off solvents for flux residual and photoresist residual, and has the advantages of nontoxic, not involving in drying and/or wastewater/waste liquid treatment, and saving valuable energy. However, it is currently an important issue as how to further enhance the element purging effect by the supercritical fluid, so as to improve the good yield and reliability of products.

### SUMMARY OF THE INVENTION

A primary object of the present invention is to provide a surface treatment method for material with surface microstructure, so that the material with surface microstructure is activated and modified, and impurities are removed from the surface microstructure to effectively upgrade the surface property of the material.

The surface treatment method for material with surface microstructure according to the present invention includes the steps of providing a material with surface microstructure, and subjecting the material to a dry-type free-radical oxidation treatment, so that free radicals cause oxidation and bond breaking of large molecule organic substances on the material surface, and the large molecule organic substances are decomposed into small molecule substances to improve the surface property of the material with surface microstructure.

The surface treatment method for material with surface microstructure according to the present invention may further includes the step of using a supercritical fluid to purge the surface of the material with surface microstructure, so as to remove oxidized and bond-broken small molecules from the material surface. The surface microstructure may include nanoholes or high-aspect-ratio microstructures. Small molecules or moistures in the nanoholes or the high-aspect-ratio microstructures are carried by the supercritical fluid away from the material with surface microstructure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a surface treatment method for material with surface microstructure according to a preferred embodiment of the present invention;

FIG. 2 shows the dielectric constant of a material having been subjected to the surface treatment method according to a first embodiment of the present invention; and

FIG. 3 is an operating electric field v. current density graph showing the electric field efficiency of a material having subjected to the surface treatment method according to a second embodiment of the present invention.

### DETAILED DESCRIPTION OF THE PREFERRED EMBODIMENTS

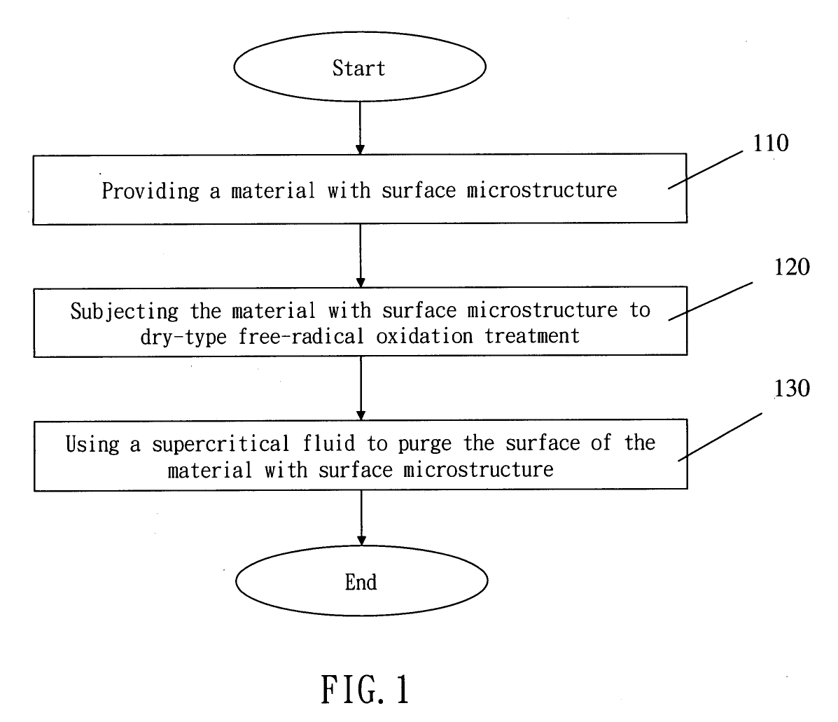

Please refer to FIG. 1, which is a flowchart showing the steps included in a surface treatment method for material with surface microstructure according to a preferred embodiment of the present invention. In a first step (110) of the surface treatment method, a material with surface microstructure is prepared. In a second step (120), the material with surface microstructure is subjected to a dry-type free-radical oxidation treatment. In a third step (130), the material with surface microstructure having been treated in the second step is purged using a supercritical fluid (SCF).

The above-described surface treatment method not only allows a material with surface microstructure to be purified and surface-modified, but also has the advantages of high efficiency and being environmentally friendly. In the dry-type free-radical oxidation treatment, free radicals cause oxidation and bond breaking of organic substances on the material surface, so that the material is improved in its surface property. The supercritical fluid may go deeply into the surface microstructure to purge off impurities, such as organic substances, without destroying the surface microstructure. Most of known supercritical fluids are in gas state under atmospheric pressure. That is, the supercritical fluid after use returns to gas state when the pressure is decreased, and automatically separates from other solid and/or liquid state substances to be easily recycled for use again.

In the preferred embodiment of the present invention, the dry-type free-radical oxidation treatment may be an ultraviolet exposure treatment, a gas-phase ozone treatment, or a combination of the above two treatments. In the ultraviolet exposure treatment, the ultraviolet ray used preferably has a wavelength within the range from 100 nm to 400 nm. In the gas-phase ozone treatment, the ozone concentration used, that is, the ratio of ozone to oxygen, is preferably lower than 17%. Moreover, the dry-type free-radical oxidation treatment may continue from 30 seconds to 5 minutes.

In the third step of purging material surface with a supercritical fluid, the supercritical fluid used may have a temperature within the range between 40° C. and 80° C., a pressure range between 1000 and 5000 pounds per square inch (psi). The supercritical fluid is kept in contact with the material surface for one minute to 60 minutes, depending on actual condition. The supercritical fluid may be a supercritical fluid of inert gas, such as carbon oxide. Carbon dioxide in a supercritical state has the ability of dissolving organic matters. Particularly, carbon dioxide has a low critical temperature of 31.2° C., which is close to a room temperature, and a critical pressure about 72.8 atm. Carbon dioxide also has the advantages of being non-toxic, non-combustible, easily available, non-expensive. Moreover, the supercritical fluid further contains from 0.5 vol % to 15 vol % of modifier, which may be alkenes, alcohols, ketones, dimethyl sulfoxide, or any combination of the aforesaid items. More specifically, the modifier may be propylene carbonate, methanol, ethyl alcohol, propyl alcohol, dimethyl sulfoxide, or any combination of the aforesaid items.

The operating process of the present invention can be more clearly understood through the following detailed description of two embodiments of the present invention.

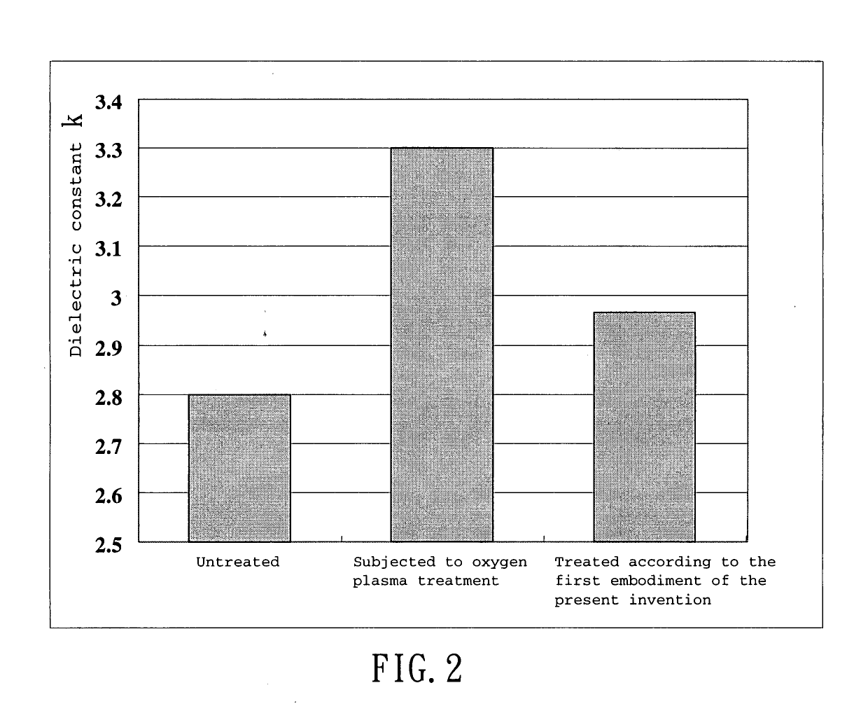

In the first embodiment of the present invention, a porous and low dielectric constant material, which is methyl-silsesquiozane (MSZ) in this embodiment, is coated on a wafer surface. The MSZ is then subjected to baking, hydrating, and curing to form a MSZ film on the wafer surface. The wafer with the MSZ film is then put into a plasma-enhanced chemical vapor deposition (PECVD) reactor for oxygen plasma treatment, followed by the ultraviolet exposure treatment. In the ultraviolet exposure treatment, the ultraviolet exposure wavelength is in the range from 185 to 254 nm, the exposure time is 5 minutes, and the exposure distance from the ultraviolet source to the wafer is about 5 cm. Thereafter, a supercritical fluid is used to purge the MSZ film surface. The supercritical fluid may include carbon dioxide supercritical fluid and 5 vol % of propylene carbonate as a modifier. Finally, a CV meter is used for electrical measurement to observe the modification of material and the purging effect. FIG. 2 shows the observed results from the surface treatment method according to the first embodiment of the present invention. As shown, the untreated MSZ film has a dielectric constant (k) of 2.8, and the MSZ film having been subjected to oxygen plasma treatment has a dielectric constant (k) of 3.3, and the oxygen-plasma treated MSZ film further subjected to the ultraviolet exposure treatment and purge by a supercritical fluid according to the present invention has a lowered dielectric constant (k) of 2.9. The oxygen-plasma treated MSZ film has an increased dielectric constant (k) of 3.3 because the oxygen plasma tends to react with the methyl group in the MSZ film to form silanol (Si—OH) cluster that is a hydrophilic group, and therefore the MSZ film is caused to absorb moisture and become degraded to result in serious leakage current at the film and increased dielectric constant. However, with the surface treatment method of the present invention, the dielectric constant of the MSZ film returns to a lower value of 2.9.

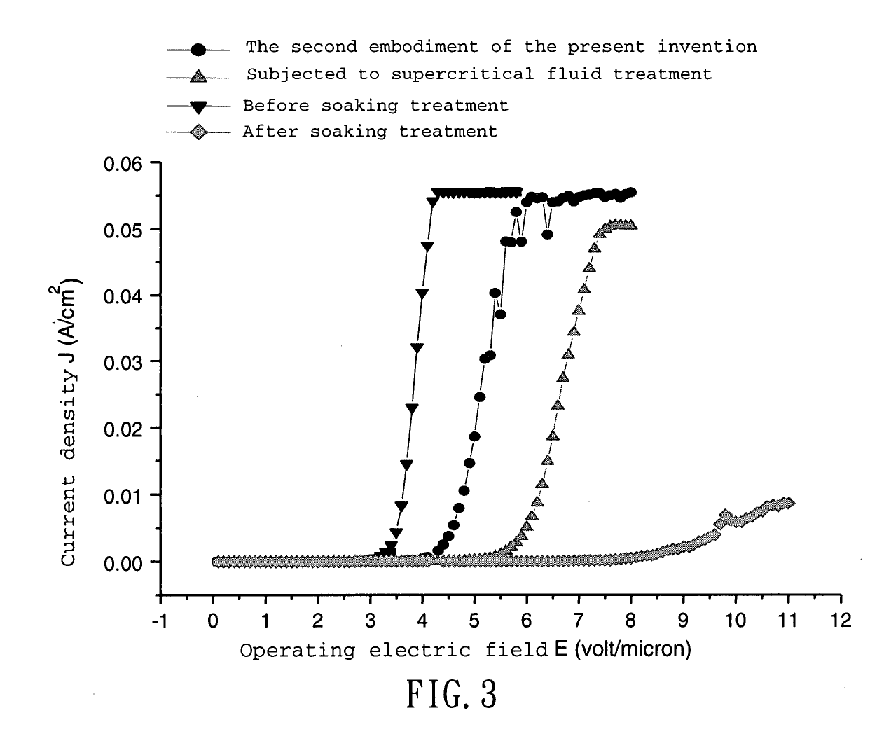

In the second embodiment, a diode carbon nanotube field emitter is prepared as the material with surface microstructure to be surface-treated. First, the diode carbon nanotube field emitter is subjected to a soaking treatment, so as to simulate electrical defects in elements caused by contamination by acids, alkali, moisture, etc. in the pattern process of the diode carbon nanotube field emitter. Tests are conducted to find any improvement in such electrical defects through the surface treatment method of the present invention. In the surface treatment according to the present invention, the diode carbon nanotube field emitter is subjected to gas-phase ozone treatment, in which the ozone concentration is 3%, and the ozone treatment time is 30 seconds. Then, the surface of the ozone-treated diode carbon nanotube field emitter is purged with a supercritical fluid, which contains carbon dioxide supercritical fluid and propyl alcohol as modifier. Finally, the surface-treated diode carbon nanotube field emitter is measured for its electrical field efficiency. FIG. 3 is an operating electric field v. current density graph showing the measured results. In the graph of FIG. 3, X-axis indicates the operating electric field, and Y-axis indicates the current density of the diode carbon nanotube field emitter. When the operating electric field is small, more electric energy can be saved. And, the steeper the curve of current density is, the easier the element can be controlled. As can be seen from FIG. 3, the soaked diode carbon nanotube field emitter has electrical defects. However, having been subjected to gas-phase ozone treatment and supercritical fluid treatment according to the present invention, the soaked diode carbon nanotube field emitter has field efficiency that has been restored to a desirable degree. The same good effect can be obtained even if the soaked diode carbon nanotube field emitter is subjected only to the supercritical fluid treatment according to the present invention.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A surface treatment method for material with surface microstructure, comprising the steps of:
providing a material with surface microstructure, and said material having been formed of at least one surface microstructure; and
conducting a dry-type free-radical oxidation treatment on said material with surface microstructure.

2. The surface treatment method for material with surface microstructure as claimed in claim 1, wherein said material with surface microstructure comprises a diode carbon nanotube field emitter or a wafer coated with a film of porous and low dielectric constant material.

3. The surface treatment method for material with surface microstructure as claimed in claim 1, wherein said surface microstructure comprises a nano hole or a high-aspect-ratio microstructure.

4. The surface treatment method for material with surface microstructure as claimed in claim 1, wherein said dry-type free-radical oxidation treatment is selected from the group consisting of ultraviolet exposure treatment, gas-phase ozone treatment, and any combination of the preceding treatments.

5. The surface treatment method for material with surface microstructure as claimed in claim 4, wherein, in said ultraviolet exposure treatment, ultraviolet ray used preferably has a wavelength within the range from 100 nm to 400 nm.

6. The surface treatment method for material with surface microstructure as claimed in claim 4, wherein, in said gas-phase ozone treatment, an ozone concentration used is lower than 17%.

7. The surface treatment method for material with surface microstructure as claimed in claim 1, wherein said dry-type free-radical oxidation treatment continues from 30 seconds to 5 minutes.

8. The surface treatment method for material with surface microstructure as claimed in claim 1, further comprising the step of using a supercritical fluid (SCF) to purge a surface of said material with surface microstructure having been subjected to said dry-type free-radical oxidation treatment.

9. The surface treatment method for material with surface microstructure as claimed in claim 8, wherein said supercritical fluid has a temperature between 40° C. and 80° C.

10. The surface treatment method for material with surface microstructure as claimed in claim 8, wherein said supercritical fluid has a pressure range between 1000 and 5000 pounds per square inch (psi).

11. The surface treatment method for material with surface microstructure as claimed in claim 8, wherein said supercritical fluid is kept in contact with said material surface for one minute to 60 minutes.

12. The surface treatment method for material with surface microstructure as claimed in claim 8, wherein said supercritical fluid comprises a supercritical fluid of an inert gas.

13. The surface treatment method for material with surface microstructure as claimed in claim 12, wherein said supercritical fluid of an inert gas comprises a supercritical fluid of carbon dioxide.

14. The surface treatment method for material with surface microstructure as claimed in claim 8, wherein said supercritical fluid contains a modifier, an amount of which is from 0.5% to 15% of a total volume of said supercritical fluid.

15. The surface treatment method for material with surface microstructure as claimed in claim 8, wherein said modifier is selected from the group consisting of alkenes, alcohols, ketones, dimethyl sulfoxide, and any combination thereof.

16. The surface treatment method for material with surface microstructure as claimed in claim 15, wherein said modifier is selected from the group consisting of propylene carbonate, methanol, ethyl alcohol, propyl alcohol, dimethyl sulfoxide, and any combination thereof.

17. A surface treatment method for material with surface microstructure, comprising the steps of:
providing a material with surface microstructure, and said material being formed of at least one surface microstructure; and
using a supercritical fluid (SCF) to purge a surface of said material with surface microstructure.

18. The surface treatment method for material with surface microstructure as claimed in claim 17, wherein said material with surface microstructure comprises a diode carbon nanotube field emitter or a wafer coated with a film of porous and low dielectric constant material.

19. The surface treatment method for material with surface microstructure as claimed in claim 17, wherein said surface microstructure comprises a nano hole or a high-aspect-ratio microstructure.

20. The surface treatment method for material with surface microstructure as claimed in claim 17, wherein said supercritical fluid has a temperature between 40° C. and 80° C.

21. The surface treatment method for material with surface microstructure as claimed in claim 17, wherein said supercritical fluid has a pressure range between 1000 and 5000 pounds per square inch (psi).

22. The surface treatment method for material with surface microstructure as claimed in claim 17, wherein said supercritical fluid is kept in contact with said material surface for one minute to 60 minutes.

23. The surface treatment method for material with surface microstructure as claimed in claim 17, wherein said supercritical fluid comprises a supercritical fluid of an inert gas.

24. The surface treatment method for material with surface microstructure as claimed in claim 23, wherein said supercritical fluid of an inert gas comprises a supercritical fluid of carbon dioxide.

25. The surface treatment method for material with surface microstructure as claimed in claim 17, wherein said supercritical fluid contains a modifier, an amount of which is from 0.5% to 15% of a total volume of said supercritical fluid.

26. The surface treatment method for material with surface microstructure as claimed in claim 17, wherein said modifier is selected from the group consisting of alkenes, alcohols, ketones, dimethyl sulfoxide, and any combination thereof.

27. The surface treatment method for material with surface microstructure as claimed in claim 26, wherein said modifier is selected from the group consisting of propylene carbonate, methanol, ethyl alcohol, propyl alcohol, dimethyl sulfoxide, and any combination thereof.
